(19) United States
(12) Patent Application Publication
(10) Pub. No.: US 2009/0031117 A1
(43) Pub. Date: Jan. 29, 2009

(54) SAME INSTRUCTION DIFFERENT OPERATION (SIDO) COMPUTER WITH SHORT INSTRUCTION AND PROVISION OF SENDING INSTRUCTION CODE THROUGH DATA

(76) Inventors: Aamir A. Farooqui, Mountain View, CA (US); Saima A. Farooqui, Mountain View, CA (US)

Correspondence Address: HAHN AND MOODLEY, LLP, P.O. BOX 52050, MINNEAPOLIS, MN, 55402, US

(21) Appl. No.: 12/016,171

(22) Filed: Jun. 16, 2008

Related U.S. Application Data
(63) Continuation of application No. PCT/US2006/003229, filed on Jan. 28, 2006.
(60) Provisional application No. 60/648,839, filed on Jan. 31, 2005.

(51) Int. Cl. G06F 9/30

(52) U.S. Cl. 712/220; 712/E09.016

(57) ABSTRACT

A same instruction different operation (SIDO) processor is disclosed in which the instruction control word is supplied using data bus as one operand and the data to be operated is supplied through another operand. Also disclosed is a method for the provision of operation-code along with data/operands using a short instruction word. With all the execution units working in parallel on multiple data operands, a variety of operations can be performed in parallel. This allows short instruction format and flexibility to dynamically program the processor on the fly by changing data/operand words, and supports basic integer operations using very simple and efficient hardware execution units.

### REFERENCE TO RELATED APPLICATION

The present application claims benefit of prior filed provisional Appl. Ser. No. 60/648,839 filed on Jan. 31, 2005, the entire content of which is hereby incorporated by reference.

### BACKGROUND OF THE INVENTION

1. Technical Field of the Invention

The present invention generally relates to the field of architecture, design and development of micro processors used for audio processing, image processing, signal processing, speech recognition and matrix processing. More particularly the invention relates to a same instruction different operation (SIDO) processor that allows short instruction format and flexibility to dynamically program the processor on the fly by changing data/operand words, and supports basic integer operations using very simple and efficient hardware execution units.

2. Description of the Related Art

Technology advancement has led to the evolution of new high performance multimedia and DSP applications, requiring high-speed computation-intensive hardware. Implementations of existing architectures cannot keep up with the demands of increased performance as they are fast approaching the bounds of circuit complexity. Several attempts have been made to counter these issues and to develop the best low-cost and high-speed architectures. In this regard the use of very long instruction word (VLIW) architecture has gained a lot of recognition.

A chip with VLIW technology is capable of executing many operations within one clock cycle. Essentially, a compiler reduces program instructions into basic operations that the processor can perform simultaneously. The operations are put into a very long instruction word that the processor then takes apart and passes the operations off to the appropriate devices. In VLIW processors several simple and short instructions are packed in a single very long instruction, and all these instructions are executed in parallel. The instruction scheduling in VLIW processors is performed statically by the compilers, therefore their hardware complexity is low as compared to superscalar processors. VLIW processors require very large instruction memories and high program memory bandwidth that tends to increase the probability of cache misses during program execution. The VLSI implementations of program memories require long wires and wide busses from instruction memory to the instruction decode/control unit. In the nano-meter VLSI design the wire delay and intrinsic parasitic is a major problem. Moreover, VLIW processors require expensive register files for multi-operand access. In a general-purpose CPU or VLIW processors, the program memory is made up of ROM, EEPROM or PROM etc., which are relatively expensive as compared to data memory. Since program memories are fixed, it is not generally possible or practical to change the flow of the program without using expensive branching techniques.

FIG. 1 illustrates a typical processor 100 that includes a data memory 102, an execution unit 105 and an instruction memory 101 according to the prior art. The data memory 102 includes memory space for operand A 103 and operand B 104. The execution unit 105 gets values from Operand-A 103 and Operand-B 104 by using the data addresses 109 provided by the instruction memory 101. The type of operation to be performed on the fetched operands by the execution unit 105 is given by instruction control word 110 supplied by the instruction memory 101. The typical operations that can be performed on the operands include addition, multiplication, shifting and negation. It should be understood that FIG. 1 is only for depicting the representative major components of a processor 100 at a high level and that the number and types of its components and operations may vary.

FIG. 2 illustrates a typical conventional VLIW processor. It shows, by way of an example, the parallel execution of four instructions by four execution/arithmetic logic units 213-216 on four pairs of operands A0 stored in register 209, B0 stored in register 205, A1 stored in register 210, B1 stored in register 206, A2 stored in register 211, B2 stored in register 207, A3 stored in register 212, B3 stored in register 208, respectively. The data operands are stored in data memory 202. The data operands are retrieved from the memory space of Operand-A 203 and Operand-B 204 using the data addresses 217 supplied from the instruction memory 201. The Operand-A and Operand-B are sent to the respective registers A and B operands using data lines 218 and 219. The operation control words 220-223 are also provided to the execution units 213-216 respectively from the instruction memory 201. A relatively larger instruction memory 201 is used for storing four operation control words and data addresses.

The present invention recognizes that it would be desirable to have a system or method that enables greater efficiency in handling execution of operations. It is also desirable that such a system or method offers a very short instruction word with large data widths and a number of short instructions are packed in a long data word. It would be further desirable to have such a system or method that is also scalable to adapt to high clock speed and wide bandwidth processor designs without requiring significant hardware upgrades. These and other benefits are provided in the present invention as described herein.

### SUMMARY OF THE INVENTION

A same instruction different operation (SIDO) processor and a method for the provision of operation-code along with data (operands) using a short instruction word are described. The data operands are stored as packed data in the memory space of Operand-A in the data memory. However, unlike conventional processors, the operation control words in the SIDO processor are stored in the data memory in the memory space of Operand-B. This results in a relatively smaller instruction memory for the storage of only one instruction operation code and data address.

The present invention allows short instruction format and flexibility to dynamically program the processor on the fly by changing operand words. The SIDO processor supports basic integer operations including add, subtract, shift, move, permute, multiply, etc. A number of permutations of the input operands and operations can be achieved by appropriately configuring the operation control word bits in Operand-B memory space, for example a 64-bit data word can allow 2⁶⁴ different combinations or permutations of operations. With all the execution units of the SIDO processor working in parallel, on multiple data operands, a variety of operations can be performed in parallel. This makes the SIDO processor a very powerful number crunching engine for computation intensive applications.

The SIDO processor according to the present invention has numerous advantages over the VLIW processors. First, in the SIDO processor, the instruction control word is supplied as operand to the execution units using data bus. Second, the SIDO processor requires smaller instruction memory. Third, the SIDO processor requires less wiring for instruction buses. Fourth, the SIDO processor requires less switching of instruction bus. Fifth, the SIDO processor requires fewer ports on registers. Sixth, the SIDO processor consumes less power. In fact, it only consumes one fourth of power that a conventional VLIW processor consumes.

Additional advantages of the present invention will be set forth in the description which follows, and in part will be obvious from the description, or may be learned by practice of the invention. The advantages of the present invention may be realized and obtained by means of the instrumentalities and combinations particularly pointed out in the appended claims.

### BRIEF DESCRIPTION OF THE DRAWINGS

FIG. 1 is a high-level block diagram illustrating the main components of a processor and their interactions with each other according to the prior art.

FIG. 2 is a block diagram of the data path section of a VLIW processor according to the prior art.

FIG. 3 is schematic diagram illustrating a comparison of SIDO instruction memory according the present invention with a VLIW instruction memory.

FIG. 4 is a schematic block diagram illustrating the architecture of a SIDO processor according to the present invention.

FIG. 5 is a schematic diagram illustrating in greater detail the design of the execution unit or arithmetic logic unit according to the invention.

FIG. 6 is a schematic diagram illustrating a 4×2 compressor 500 used in an exemplary execution unit implementation of the present invention.

FIG. 7 is a table listing exemplary bit allocations of the instruction control word.

FIG. 8 is a table listing an exemplary bit-wise assignment for a 16-bit instruction packed as data.

FIG. 9 is a table listing an exemplary control word calculation.

FIG. 10 is a table listing another exemplary control word calculation.

FIG. 11 is a table listing exemplary instruction control word for 4×4 matrix multiplication.

FIG. 12 is a table listing exemplary transform 4×4 matrix multiplication routine.

FIG. 13 is a diagram illustrating a typical instruction format for a SIDO instruction.

FIG. 14 is a flow diagram illustrating the steps that a SIDO processor performs an operation.

FIG. 15 is a block diagram illustrating an 8×8 SIMD SIDO processor.

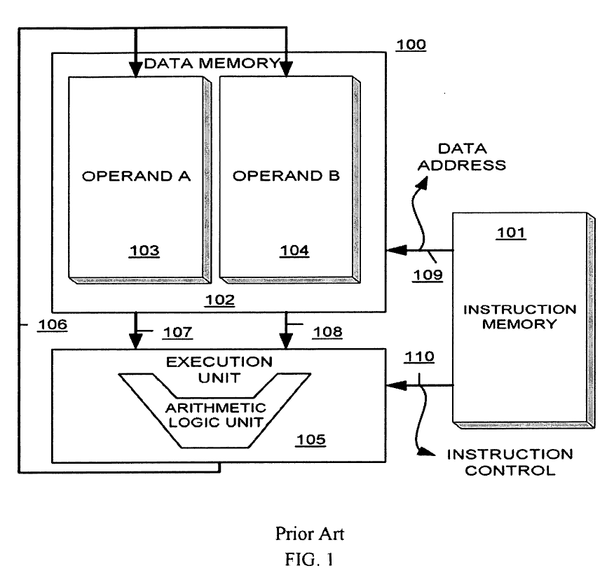

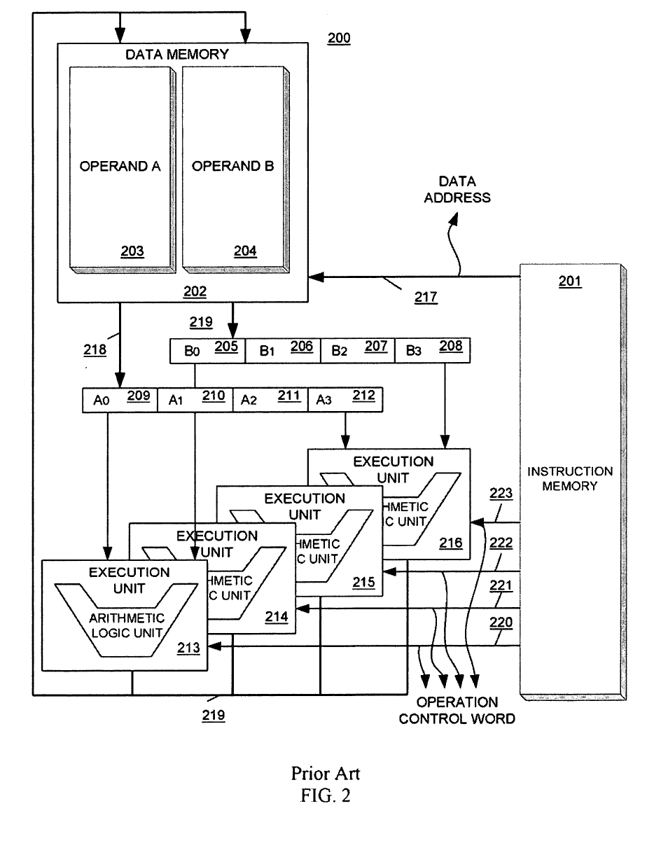

### DETAILED DESCRIPTION OF THE INVENTION

The present invention is best understood by referring to the accompanying figures and the detailed description set forth herein. Embodiments of the invention are discussed below with reference to the figures. However, those skilled in the art will readily appreciate that the description given herein with respect to the figures is for explanatory purposes as the invention extends beyond these limited embodiments.

Terminology: Given below is a list of definitions of the technical terms which are frequently used in this document:

Operands and operators—Operands refer to the objects that are manipulated and operators refer to the symbols that represent specific operations. For example, in the expression Y+7, Y and 7 are operands and + is an operator. In this document, “operands”, “data operands”, and “data words” are interchangeably used; “operator”, “operation code”, and “operation control word” are interchangeably used.

Operation control word—A predefined code which defines what operation needs to be performed, e.g. 000 for addition, 001 for subtraction, 010 for shift etc. Operation control word is used by the hardware controller to generate proper control signals for a particular operation.

Instruction—A basic command, such as the most rudimentary programming commands comprised of operation codes and data addresses.

Instruction control word—Instruction operation code, also known as opcode or op_code. In this invention, instruction control word is supplied by the instruction memory which is separated from the data memory.

Bus—A collection of wires through which data is transferred. All buses consist of two parts: an address bus and a data bus. The data bus transfers actual data whereas the address bus transfers information about where the data should go. Every bus has a clock speed measured in MHz.

Register—A temporary storage area in computers.

Execution unit—A device for performing logic operations. In a processor like the SIDO processor according to the present invention, the execution unit comprises at least one arithmetic logic unit.

Multiplexer—A multiplexer combines more than one input into a single output. The input selection is performed or controlled by an input select signal. For example, a two-input multiplexer is a simple connection of logic gates whose output Y is either input A or input B depending on the value of a third input S which selects the input.

Compressor—One of the major speed enhancement techniques used in modern digital circuits is the ability to add numbers with minimal carry propagation. For example, a 3:2 compressor reduces three numbers to 2, by doing the addition while keeping the carries and the sum separate. This means that all of the columns can be added in parallel without relying on the result of the previous column, creating a two output “adder” with a time delay that is independent of the size of its inputs.

Ripple carry adder—A ripple carry adder allows the addition of two k-bit numbers to produce one k-bit output. The addition is performed using carry propagation from bit-0 to n.

Shifter—A hardware device that can shift a data word by any number of bits in a single operation. It is implemented like a multiplexer. Each output can be connected to any input depending on the shift distance.

The present invention teaches a same instruction different operation (SIDO) processor which allows a very short instruction word with large data widths. One of the distinct characteristics of the SIDO processor is that it makes several simple and short instructions packed in a long data word. In today's high performance computers, large data widths of 64, 128, or 256 are common. Therefore, storing instruction operation code as data words is very appealing for high performance processing. The SIDO processor allows short instruction format and flexibility to dynamically program the processor on the fly by changing operand words, and supports basic integer operations including add, subtract, shift, move, permute etc., using very simple and efficient hardware execution units. A number of permutations of the input operands and operators can be achieved by appropriately configuring the operation control word bits in data memory on the fly.

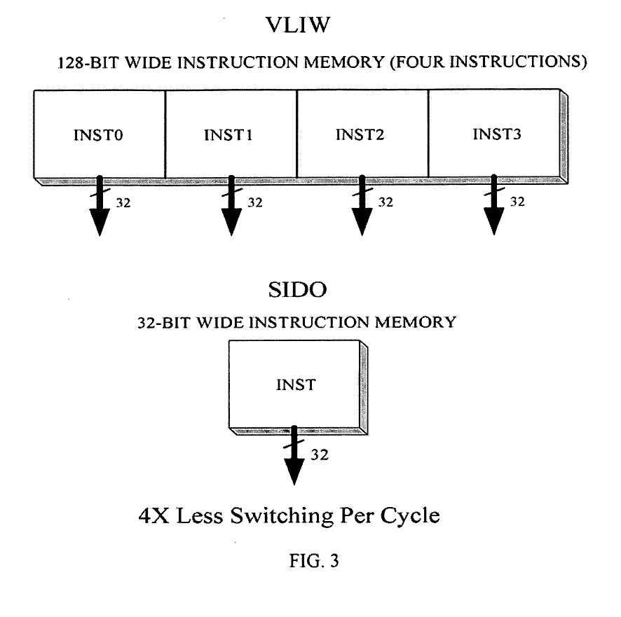

Referring to FIG. 3, which illustrates a comparison of the SIDO instruction memory according to the present invention with a VLIW instruction memory. In the VLIW processor, 128-bit wide instruction memory is required for executing four instructions. In the SIDO processor, however, only 32-bit wide instruction memory is required. It is demonstrated that in many applications the SIDO processor requires four times less instruction memory as compared to the traditional VLIW processors but has better performance. In other words, a SIDO processor only requires one fourth of the instruction memory that a VLIW processor usually requires. This eventually transforms to four times less wiring for instruction buses and less power consumption due to less switching of instruction buses. This is a major performance leap.

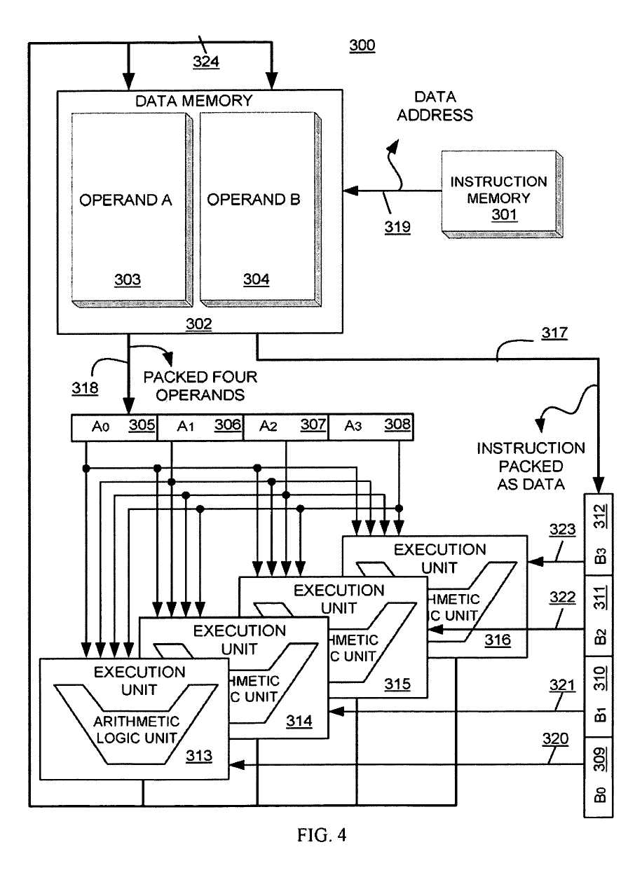

FIG. 4 illustrates an exemplary architecture of a SIDO processor according to one preferred embodiment of the present invention. The SIDO processor includes at least one memory for storing at least two data operands and one or more execution units which performs operations in parallel. One of the data operands is specifically used to provide the execution units with one or more operation control words to perform operations on the remaining data operands. The SIDO processor may further include an additional memory for storing instruction code and data addresses. In the SIDO processor, a same instruction may use different data code to perform different operations, and different instructions may use a same data code to perform different operations. For the purpose of parallelism, each of the operation control words is applied to each of the remaining data operands, i.e. the data operands other than the operand specifically for operation control words. The number of operations performed in parallel increases with the number of data operands. The number of execution units can be scalable. In addition, a same operation control word may be supplied to two or more of the execution units concurrently. The architecture enables the parallel execution of four instructions by four arithmetic logic units 313-316 on four pairs of 16-bit operands: operand 305 stored in register A0, operand 306 stored in register A1, operand 307 stored in register A2, and operand 308 stored in register A3 respectively. All data operands are stored in data memory 302. The instruction memory 301 is wholly, or at least substantially, for storing data addresses and op-codes, and thus it may be relatively small. In execution, the data operands are retrieved from the memory space of Operand-A 303 using the data addresses 319 supplied from the instruction memory 301. The four 16-bit data words are concatenated as 64-bit data and stored in the memory space of Operand-A 303. A 64-bit data bus 318 is used to load registers A0-A3 in parallel from the data memory 302. The bit positions for the registers are divided into four groups which are loaded concurrently. The most significant 16 bits group starting from the bit position bit-63 to bit-48 is loaded into register A3; the second group starting from the bit position bit-47 to bit-32 is loaded into register A2; the third group starting from the bit position bit-31 to bit-16 is loaded into register A1; and the fourth group starting from the bit position bit-15 to bit-0 is loaded into register A0: In other words, each of the registers A0-A3 is loaded with a unique section of data which represents a unique series of bit positions.

The operation control words 320-323 for the operation of execution units 313-316 are also provided from the data memory Operand-B 304. The four 16-bit operation control words are concatenated as 64-bit operation control word in the memory space of Operand-B 304. A 64-bit data bus 317 is used to load registers B0-B3 in parallel from the data memory 302. The 16-bit operation control words (OCW): OCW 309 stored in register B0, OCW 310 stored in register B1, OCW 311 stored in register B2 and OCW 312 stored in register B3. The bit positions for the registers are divided into four groups which are loaded concurrently. The most significant 16 bits group starting from the bit position bit-63 to bit-48 is loaded into register B3; the second group starting from the bit position bit-47 to bit-32 is loaded into register B2; the third group starting from the bit position bit-31 to bit-16 is loaded into register B1; and the fourth group starting from the bit position bit-15 to bit-0 is loaded into register B0. In other words, each of the registers B0-B3 is loaded with a unique section of a control word which represents a unique series of bit positions. Note that the contents of registers B0-B3 are not treated as data; rather, they are treated as 16 bit operation control words.

The four 16-bit operation control words are packed in the 64-bit Operand-B 304 and operate on the four execution units 313-516 in parallel: OCW 320 being applied to execution unit 313, OCW 321 being applied to execution unit 314; OCW 322 being applied to execution unit 315; and OCW 323 being applied to execution unit 316. In other words, each of the registers B0-B3 is loaded with a unique section of a control word which represents a unique series of bit positions. Note that the contents of registers B0-B3 are not treated as data; rather, they are treated as 16-bit operation control words.

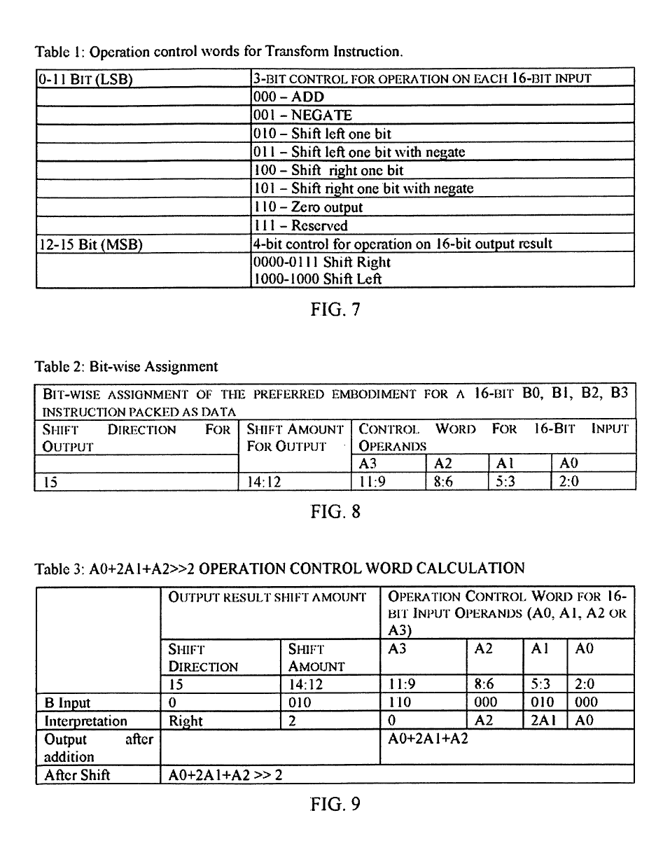

Table 1 of FIG. 7 lists by way of example the bit encoding for 16-bit operation control words (B0-B3). It must be noted that a different bit encoding can be used to perform different functions. The operations that can be executed on the input operands (A0, A1, A2, or A3) are supplied using bits 0-11 of the 16-bit operation control words. These operations include, but are not limited to:
000—ADD (add (+) A0, A1, A2, or A3 to other operands)
001—NEGATE (subtract (−) A0, A1, A2, or A3 from other operands)
010—SHIFT LEFT ONE BIT (shift left A0, A1, A2, or A3)
011—SHIFT LEFT ONE BIT WITH NEGATE (shift left A0, A1, A2, or A3 AND THEN SUBTRACT (−) A0, A1, A2, or A3 from other operands)
100—SHIFT RIGHT ONE BIT (shift right A0, A1, A2, or A3)
101—SHIFT RIGHT ONE BIT WITH NEGATE (shift right A0, A1, A2, or A3 AND THEN SUBTRACT (−) A0, A1, A2, or A3 from other operands)
110—ZERO OUTPUT (zero output)
111—RESERVED

The operations that can be executed on the result of the above operations are supplied using bits 12-15 of the 16-bit operation control words. These operations include but are not limited to variable eight position shift left or right of the result. Each 16-bit instruction control word of the preferred embodiment is divided into a 12-bit operation code for operation on input operands A0-A3 and a 4-bit operation code for output shift amount. The first 3-bit group of the 12-bit operation code starting from the least significant bits (LSB) position bit0 to bit2 defines the operation to be performed on the input operands 305 A0; the second 3-bit group starting from the bit position bit3 to bit5 defines the operation to be performed on the input operands 306 A1; the third 3-bit group starting from the bit position bit6 to bit8 defines the operation to be performed on the input operands 307 A2; and the fourth 3-bit group starting from the bit position bit8 to bit11 defines the operation to be performed on the input operands 308 A3.

As shown in Table 2 of FIG. 8, the most significant 4 bits group starting from the bit position bit12 to bit15 is used for 8-bit shift operation on the 16-bit output result of A0-A3. The most significant bits (MSB) or bit 15 of this group defines the direction of shift, while the remaining 3-bits i.e. bits 14:12 define the number of bits to be shifted of the output in that direction. Using the values from FIG. 7, a variety of operations can be performed on the input operands by configuring the bits of control words to get the desired results. The unique feature of this SIDO instruction is the provision of operation code along with the operands.

In another preferred embodiment, the SIDO data processor includes a device or an algorithm for concatenating one or more operation control words in a first operand, a device or an algorithm for concatenating data words in one or more data operands, at least one memory for storing the first operand and the data operands, a first set of registers being loaded in parallel with the first operand, a second set of registers being loaded in parallel with the data operands, one or more execution units using the operation control words decoded from the first operand to perform operations on the data operands. Note that the number of the first set of registers is equal to the number of the execution units. Each of the first set of registers is loaded with a unique section of the first operand. The unique section of the first operand is representative of a group operation control words at a unique series of bit positions. For example, as illustrated in FIG. 4, The most significant 16 bits group starting from the bit position bit-63 to bit-48 is loaded into register B3; the second group starting from the bit position bit-47 to bit-32 is loaded into register B2; the third group starting from the bit position bit-31 to bit-16 is loaded into register B1; and the fourth group starting from the bit position bit-15 to bit-0 is loaded into register B0. Each of the execution units includes one or more multiplexers. Each of the multiplexers is assigned one of the data operands loaded into the second set of registers. Each of the first set of registers applies eight basic operation commands to each of the data operands as inputs of each of the multiplexer. Each of the multiplexers has one output. Each of the execution units may further include (1) a compressor, to which the outputs of the multiplexers are routed for addition operation; (2) a carry propagate adder, such as a ripple carry adder, to which outputs of the compressor are fed for further addition; and (3) a bi-direction shifter, to which the carry propagate adders output and a series of control commands are fed for defining a final output. In operation, a group of inverters associated with the data operands (via Multiplexer) and a logic one are fed to the compressor for negation operation. At least one of the inverters performs a SHIFT 1 bit with NEGATE function by a hardwired shift. The shifter is a bi-direction shifter controlled by the most significant bits (MSB) of the operation control word.

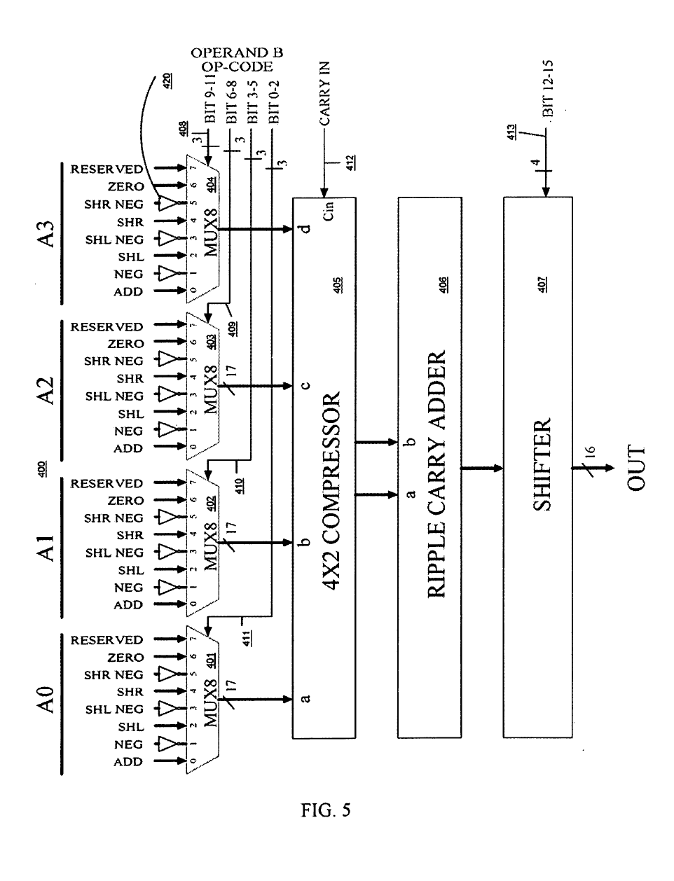

FIG. 5 illustrates by way of example an execution unit 400 according to the above mentioned embodiment of the present invention. The execution unit 400 is responsible for performing the operations on four 16-bit operands A0-A3 packed in the 64-bit register as defined by the 16-bit OCW B0, OCW B1, OCW B2, or OCW B3. The execution unit 400 receives 16-bit OCW that is configured to achieve the desired results. Each execution unit consists of four 8-to-1 Multiplexers (MUXes) 401-404, one 16-bit 4×2 compressor, one carry propagate adder such as a ripple carry adder, and a 16 bit shifter. Each multiplexer of the execution unit 400 is assigned one of the four input operands A0-A3: Multiplexer 401 receiving input operand A0; Multiplexer 402 receiving input operand A1; Multiplexer 403 receiving input operand A2; and Multiplexer 404 receiving input operand A3. Each multiplexer selects one of the eight input lines including (1) addition, (2) negation, (3) shift left, (4) shift left with negation, (5) shift right, (6) shift right with negation, (7) forced to zero of that input operand, and (8) reservation. The multiplexer selection is performed according to the 3-bit instruction control word 408, 409, 410, or 411: the first 3-bit group starting from the least significant bits (LSB) positions bit0 to bit2 defining the operation to be performed on the input operands A0 and being applied at the selection lines of Mux 401; the second 3-bit group starting from the bit position bit3 to bit5 defining the operation to be performed on the input operands A1 and being applied at the selection lines of Mux 402; the third 3-bit group starting from the bit position bit6 to bit8 defining the operation to be performed on the input operands A2 and being applied at the selection lines of Mux 403, and the fourth 3-bit group starting from the bit position bit9 to bit11 defining the operation to be performed on the input operands A3 and being applied at the selection lines of Mux 404.

The 16-bit outputs a-d from all of the four multiplexers 401-404 respectively are routed to the 4×2 compressor 405 for addition. To perform a negation operation, the input operands A0-A3 are inverted using inverters 420, and logic one is input as Carry-in 412 which is also fed to compressor 405. Carry-in 412 and the outputs a-d are all summed up by using a tree of adders in compressor 405. Sum and carry vectors that are generated by compressor 405 are sent to a carry propagate adder such as a ripple carry adder 406 for addition to obtain the final output. Then, the result of the ripple carry adder 406 is sent to a shifter 407 that receives output-controls 413 from the four most significant bits (MSB) 15:12 of the operation control word. The output-control signals define the direction and number of bits the output needs to be shifted to yield the final 16-bit result.

In this embodiment, the execution units 313-316 in FIG. 4 are substantially identical despite the corresponding operation control words are different: the instruction control word 320 being applied to the execution unit 313, the instruction control word 321 being applied to the execution unit 314, the instruction control word 322 being applied to the execution unit 315, and the instruction control word 323 being applied to execution unit 316. The fact shows the scalability of the SIDO architecture. With all four execution units working in parallel, sixteen operations are performed in parallel and four outputs are produced according to the preferred embodiment of the present invention. Those skilled in the art will appreciate the strength and usefulness of the present invention in computation intensive applications. A number of permutations of the input operands can be achieved by appropriately configuring the operation control word bits.

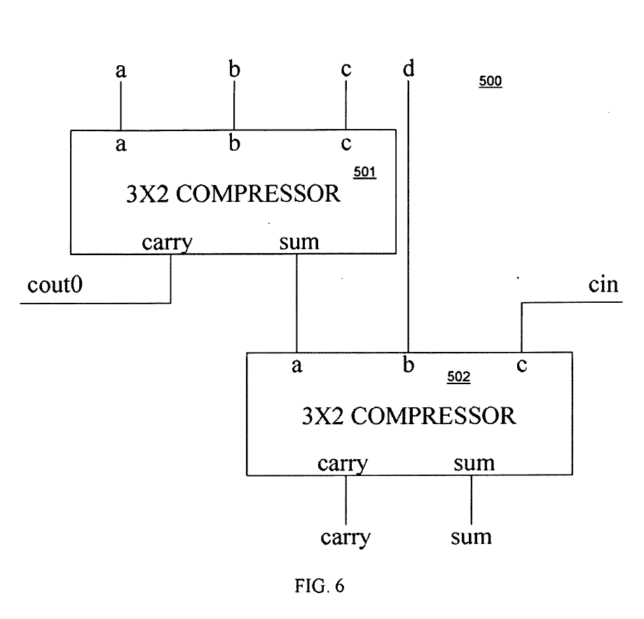

Now referring to FIG. 6 which illustrates a 4×2 compressor 500 used in an exemplary execution unit implementation according to the present invention. The compressor 500 is comprised of two 3×2 compressors 501-502 cascaded together. The first 3×2 compressor 501 operates like a full adder that accepts three inputs a-c, and sums them up to yield a sum and carry cout0. The second 3×2 compressor 502 receives the sum output from the compressor 501, the fourth input d and the Carry-in cin input, and computes their sum to yield the final sum and carry cout1. The two carry out cout0 and cout1 are then added using the ripple carry adder 406 as shown in FIG. 5.

Here are a few examples: If A0:A1:A2:A3 are 416-bit input operands packed as 64 bit in Operand-A, and the operation control words are provided using 4-16-bit words packed in Operand-B, then, based on the configuration, words output can be (A0+A1+A2+A3)<<shift left: (A0−A1−A2−A3)>>shift right: (A0+A1-A2+A3) no shift (A0−A1+A2−A3)<<shift left from all four execution units at the same time. Different operations between A0, A1, A2, and A3 are based on the configuration word in Operand-B. The instruction configuration is based on the 16-bit values given in Table 1 of FIG. 7 for each 16-bit output.

Table 3 of FIG. 9 illustrates by way of example the configuration code for A0+2A1+A2+2>>2, in which the input control bits 2:0 are ‘000’ to make A0=1×A0; bits 5:3 is ‘010’ to make A1=2×A1; bits 8:6 is ‘000’ to make A2=1×A2, and bits 11:9 is ‘110’ to make A3=0. Similarly, output control bits 15:12 is 0010 to perform shift right by 2 on the output result.

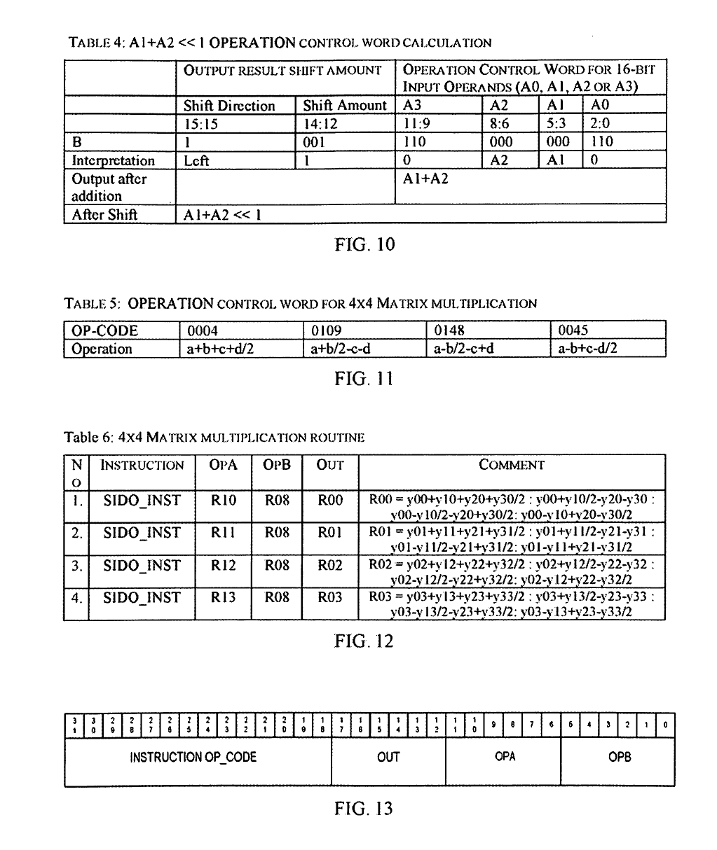

Table 4 of FIG. 10 illustrates by way of example the configuration code for A1+A2 <<1, in which the input control bits 2:0 are ‘110’ to make A0=0; bits 5:3 and 8:6 are ‘000’ to make A1=1×A1, and A2=1×A2; bits 11:9 are ‘110’ to make A3=0. Likewise, output control bits 15:12 are 1001 to perform left shift by 1-bit position on the output result.

Table 5 of FIG. 11 lists OCW for 4×4-matrix multiplication.

Table 6 of FIG. 12 illustrates, by way of example, and not limitation, a typical 4×4 matrix multiplication transformation. As shown in the following equation, a single SIDO processor may be configured to execute 4×4 matrix multiplication in four instructions by appropriately setting the control word in data memory.

To perform the 4×4 matrix multiplication using the SIDO processor, the input matrix columns are stored in a 64-bit wide data registers R00-R15 of a typical processor and packed as 4-16 bit words: the first column (y00-y30) is stored in R10; the second column (y01-y31) is stored in R11; the third column (y02-y32) is stored in R12; and the fourth column (y03-y33) is stored in R13 as shown below:

R10 y00:y10:y20:y30
R11 y01:y11:y21:y31
R12 y02:yl2:y22:y32
R13 y03:yl3:y23:y33

The operation control words for the matrix multiplication are stored in register R08 and packed as 4-16 bit words. Using Table 1 of FIG. 7, the operation code for operation a+b+c+d/2 is 0004 (decimal) 0000 0000 0000 0100 (binary) and is stored in the 16-bit MSB (bit63−bit48) of R08. Similarly, the operation code for a+b/2−c−d is 0109 (decimal) 0109 0000 0001 0000 1001 (binary) and is stored in the third 16 bit word (bit47−bit32) of R08. The operation code for a−b/2−c+d is 0148 (decimal) 0000 0001 0100 1000 (binary) and is stored in the second 16-bit word (bit31−bit16) of R08. Finally, the operation code for a−b+c−d/2 is 0045 (decimal) 0000 0000 0100 0101 (binary) and is stored in the least significant bits (LSB) 16-bit word (bit15−bit0) of R08.

FIG. 13 illustrates a typical instruction format for a SIDO instruction.

BIT [31:18] is for INSTRUCTION OPCODE. The 14-bit operation control words represent the control word for different instructions of a typical processor. One of these instruction codes could be SIDO type. For the sake of explanation, the SIDO instruction op_code is 1 (decimal) 00 0000 0000 0001 (binary).

BIT [17:12] is for OUT. The 6-bit code is for output register or memory write address.

BIT [11:6] is for OPA. The 6-bit code is for Operand-A register or memory read address (from memory space of Operand-A 303 of FIG. 4). This address is used to load 64-bit data registers A0-A3 in parallel from the data memory 302.

BIT [5:0] is for OPB. The 6-bit code is for Operand-B register or memory read address (from the data memory Operand-B 304 of FIG. 4). This address is used to load the 64 bit operation control words 320-323 as 16-bit instruction op-code: 309 in register B0, 310 in register B1, 311 in register B2 and 312 in register B3.

In another preferred embodiment, the present invention is deployed as a method or process. The data processor includes at least one memory for storing data operands, at least one memory for storing instruction code and data addresses, and at least one execution unit. One of the data operands is specifically used to provide the execution units with one or more operation control words to execute operations on the remaining data operands. The basic steps of the method or process include: fetching the data operands, decoding the operation control word from one of the data operands in parallel, and executing the operations by applying the operation control word to the remaining operands. The step of fetching the data operands may include various sub-steps. For example, fetching instruction, decoding instruction and generating data operands addresses, reading the control word using the data operand for control words, reading the remaining data operands, storing the control word into a first set of registers, and storing the remaining data operands in a second set of registers. Upon execution, the processor writes the result of the step of executing as an output. The operations performed by the processor include, but not limited to, ADD, NEGATE, SHIFT LEFT 1 bit, SHIFT LEFT 1 bit with NEGATE, SHIFT RIGHT 1 bit, SHIFT RIGHT 1 bit with NEGATE, ZERO, MULTIPLICATION. Prior to the step of writing the result, further operations may be made on the result of the step of executing of writing. The further operations' may include any of: shifting left, shifting right, addition, subtraction, multiplication, division, saturation, rounding, and logical operations such as AND, OR, XOR, XNOR, NOR, NAND.

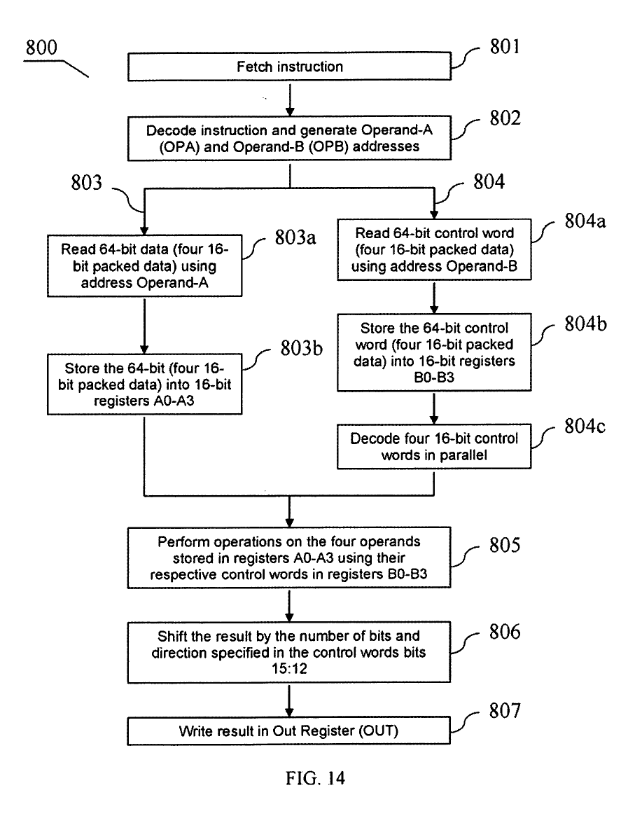

FIG. 14 illustrates the steps of a process 800 for performing an operation according to the preferred embodiment illustrated in FIGS. 4-6:

Step 801: Fetch instruction.

Step 802: Decode instruction and generate Operand A and Operand B addresses.

Step 803 and Step 804 are concurrently executed steps, wherein Step 803 includes sub-steps 803a-803b, and Step 804 includes sub-steps 804a-804c.

Sub-step 803a: Read 64 bit data (four 16-bit packed data) using address Operand-A.

Sub-step 803b: Store the 64-bit data (four 16-bit packed data) into four 16-bit registers A0-A3 of FIG. 4.

Sub-step 804a: Read 64-bit control word (four 16-bit packed data) using address Operand-B.

Sub-step 804b: Store the 64-bit control word (four 16-bit packed data) into four 16-bit registers B0-B3 of FIG. 4.

Sub-step 804c: Decode four 16-bit control words in parallel: bit 0-2, operation control for A0; bit 3-5, operation control for A1; bit 6-8, operation control for A3; and bit 12-15, direction Left/Right and number of bits output result to be shifted.

Step 805: Perform sixteen operations on the four operands stored in registers A0-A3 using their respective operation control words in registers B0-B3 in parallel.

Step 806: Shift the four output results produced in Step 805 by the number of bits and direction specified in the control word bits 12-15.

Step 807: Write the calculation result in Out Register (OUT).

Referring back to FIG. 4-FIG. 6, it must be noted that a different bit encoding can be used to perform different operations and perform different functions. The operations that can be executed on the input operands include, but are not limited to the one as shown in FIG. 7. A different implementation of the SIDO processor is possible using different implementation techniques, but the main idea remains the same, i.e., supplying the instruction code or OCW through the data operands.

Although the SIDO solution based on the foregoing exemplary illustrations is applied only to simple operations such as addition, subtraction, negation etc., the same concept can be applied to more complex instructions such as multiplication and division by small numbers. In case of multiplication, the 16-bit control word can represent 4 multipliers of 4 bit each. Using this approach a single SIDO instruction can perform operations similar to the following:
(2*A0−3*A1+4*A2−5*A3):(6*A0−7*A1−4*A2−5*A3):(2*A0+7*A1−4*A2+5*A3):(2*A0+1*A1−4*A2+6*A3)

In the preferred embodiment illustrated in FIG. 4-FIG. 6, the operation control word is applied using operand-B memory. In other equally preferred employments, the same operation control word can be stored in the instruction memory of the processor, hence reduce system memory and power. The SIDO concept can also be applied to RISC, SIMD, and VLIW architectures. Those skilled in the art will readily appreciate the attendant efficiencies gained by using SIDO over RISC or VLIW processors. By way of example, and not limitation, the above mentioned 4×4 matrix multiplication requires approximately 64 RISC instructions for only arithmetic operations and several load-store operations. However, a VLIW with 4 execution units require 16 VLIW Instructions and several load-store operations. On the other hand, a SIDO processor with four simple execution units requires only 4 SIDO Instructions with minimum instruction memory and flexibility of on the fly program change.

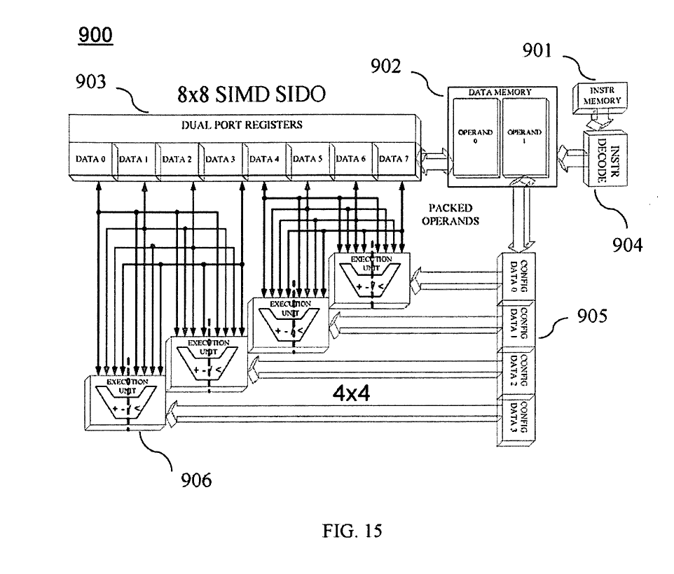

FIG. 15 illustrates an 8×8 SIMD SIDO processor according to the present invention. As an example of an application of this invention, the processor includes an instruction memory 901 coupled to an instruction decode device 904, a data memory 902 which obtains addresses from the instruction memory 901, and four SIMD 16-8 execution units such as 905. The data operand, such as OPERAND0 are concatenated or packed as eight 8-bit data operands, stored in the 64-bit data memory 902 are transferred via a 64-bit wide data bus to eight registers 903 which are coupled in parallel to each of the four SIMD 16-8 execution units. The operation control words are packed as 16-bit data operand packed or concatenated as 64-it data operand, such as OPERAND1, and stored in the 64-bit data memory 902. Four configuration registers 905 are loaded, via a 64 bit data bus, with operation control words from the OPERAND1. Each 16-bit operation control word is applied, in parallel, to each SIMD execution unit, which performs same operations on two sets of 8 bit operands. This in turn produces eight output results in parallel.

Typical applications of the present invention include, but are not limited to, the compute intensive tasks in audio processing, video processing, image processing, JPEG, H.264, MPEG, signal processing, speech coding, speech recognition, computer vision, matrix processing, vector math, cryptography, and the like. All of these applications require large number of arithmetic operations. Therefore, the SIDO solution provided in the present invention is the right choice of architecture for these applications.

Although the invention has been described with reference to at least one specific embodiment, this description is not meant to be construed in a limiting sense. Various modifications of the disclosed embodiment, alternative embodiments or other equivalent solutions of implementing the disclosed SIDO processor with short instructions and provisions of sending operands will become apparent to those skilled in the art upon reference to the description of the invention. It is therefore contemplated that such modifications, equivalents, and alternatives can be made without departing from the spirit and scope of the present invention as defined in the appended claims.

1. A data processor comprising:
at least one execution unit; and
at least one memory for storing at least two data operands;
wherein one of the data operands is used to provide the at least one execution unit with one or more operation control words to perform operations on the remaining data operands.

2. The data processor of claim 1, further comprising at least one memory for storing instruction code and data addresses.

3. The data processor of claim 1, wherein the at least one execution unit performs operations in parallel.

4. The data processor of claim 1, wherein a same instruction may use different data code to perform different operations.

5. The data processor of claim 1, wherein different instructions may use a same data code to perform different operations.

6. The data processor of claim 3, wherein each of the operation control words is applied to each of the remaining data operands.

7. The data processor of claim 6, wherein the number of operations performed in parallel increases with the number of data operands.

8. The data processor of claim 7, wherein the number of execution units is scalable.

9. The data processor of claim 3, wherein a same operation control word may be supplied to two or more of the execution units concurrently.

10. In a data processor which comprises at least one execution unit, at least one memory for storing instruction code and data addresses, and at least one memory for storing data operands, one of the data operands being used to provide the at least one execution unit with one or more operation control words to execute operations on the remaining data operands, a method for processing data comprising the steps of:
fetching the data operands;
decoding the operation control word from one of the data operands in parallel; and
executing the operations by applying the operation control word to the remaining operands.

11. The method of claim 10, wherein the step of fetching the data operands comprising the sub-steps of:
fetching instruction;
decoding instruction and generating data operands addresses;
reading the control words from the data operand for control words; and
reading the data words from remaining data operands.

12. The method of claim 11, further comprising the sub-steps of:
storing the control words into a first set of registers; and
storing the data words in a second set of registers.

13. The method of claim 10, further comprising the step of:
writing the result of the step of executing as an output.

14. The method of claim 10, wherein the operations comprise any of: ADD, NEGATE, SHIFT LEFT 1 bit, SHIFT LEFT 1 bit with NEGATE, SHIFT RIGHT 1 bit, SHIFT RIGHT 1 bit with NEGATE, ZERO, and MULTIPLICATION.

15. The method of claim 13, further comprising the step of:
prior to the step of writing output, making further operations on the result of the step of executing.

16. The method of claim 15, wherein the further operations comprise any of: shifting left, shifting right, addition, subtraction, multiplication, division, saturation, rounding, and logical operations comprising any of: AND, OR, XOR, XNOR, NOR, NAND.

17. The method of claim 10, wherein the at least one execution unit executes operations in parallel.

18. The method of claim 10, wherein a same instruction may use different data code to perform different operations.

19. The method of claim 10, wherein different instructions may use a same data code to perform different operations.

20. The method of claim 17, wherein any of the operation control words is applied to each of the remaining data operands.

21. The method of claim 20, wherein the number of operations performed in parallel increases with the number of data operands.

22. The method of claim 21, wherein the number of execution units is scalable.

23. The method of claim 22, wherein a same operation control word may be supplied to two or more of the execution units concurrently.

24. A data processor comprising:
means for concatenating one or more operation control words in a first operand;
means for concatenating data words in one or more data operands;
at least one memory for storing the first operand and the data operands;
a first set of registers being loaded in parallel with the first operand;
a second set of registers being loaded in parallel with the data operands; and
one or more execution units using the operation control words decoded from the first operand to perform operations on the data operands.

25. The processor of claim 24, wherein an operator is applied on each of the data operands.

26. The data processor of claim 24, wherein the number of the first set of registers is equal to the number of the execution units, each of the first set of registers being loaded with a unique section of the first operand, the unique section of the first operand being representative of a group operation control words at a unique series of bit positions.

27. The processor of claim 26, wherein each of the execution units comprises one or more multiplexer, each of which being assigned one of the data operands loaded into the second set of registers, each of the first set of registers applying eight basic operation commands to each of the data operands as inputs of each of the multiplexer, each of the multiplexer having one output; and wherein each of the execution units further comprises:
a compressor, to which the outputs of the multiplexers are routed for addition operation;
a carry propagate adder, to which outputs of the compressor are fed for further addition; and a shifter, to which the carry propagate adder's output and a series of control commands are fed for defining a final output.

28. The data processor of claim 27, wherein a group of inverters associated with the data operands and a logic one are fed to the compressor for negation operation.

29. The data processor of claim 28, wherein at least one of the inverters performs SHIFT 1 bit with negate function by a hardwired shift.

30. The data processor of claim 27, wherein a SHIFT 1 bit operation is performed by a hardwired shift of the data operands.

31. The data processor of claim 27, wherein the shifter is a bi-direction shifter controlled by the most significant bits of the operation control word.

32. The processor of claim 27, wherein the number of execution units is four;
wherein the number of the first set of registers is four; and wherein the number of the second set of registers is four.
